(19) United States
(12) Patent Application Publication
(10) Pub. No.: US 2008/0188394 A1
(43) Pub. Date: Aug. 7, 2008

(54) Glass and Hard Surface Cleaning Composition

(75) Inventor: Diane Joyce Burt, Montvale, NJ (US)

Correspondence Address: NORRIS, MCLAUGHLIN & MARCUS, 875 THIRD AVE, 18TH FLOOR, NEW YORK, NY, 10022, US

(73) Assignee: RECKITT BENCKISER INC., Parsippany, NJ (US)

(21) Appl. No.: 11/912,367

(22) PCT Filed: May 3, 2006
(86) PCT No.: PCT/GB2006/001594

§ 371 Date: Nov. 30, 2007

(30) Foreign Application Priority Data
May 5, 2005 (GB) 0509120.2

(51) Int. Cl. C11D 1/75; C11D 17/00

(52) U.S. Cl. 510/406; 510/405

(57) ABSTRACT

Improved cleaning compositions useful in the cleaning of hard surfaces, particularly in the cleaning of glass and hard surfaces, particularly hard surfaces having a shiny or reflective character. Preferred compositions comprise amine oxide as the sole surfactant constituent, an alkanolamine, especially monoethanolamine as the sole organic solvent constituent, and water, optionally further including a dye and/or fragrance composition. The compositions provide excellent cleaning and exhibit a low streaking or non-streaking character.

The present invention relates to improved cleaning compositions useful in the cleaning of hard surfaces, particularly in the cleaning of glass and hard surfaces, particularly hard surfaces having a shiny or reflective character.

While the art is replete with a large number of cleaning compositions useful for the cleaning and or disinfection of hard surfaces, only a small fraction of these compositions are useful in the cleaning of glass and other glossy or shiny hard surfaces. Ideally, the cleaning of such surfaces requires that effective cleaning of surface soils and deposits, including inter alia, hydrophobic soils such as oils or greases be provided while at the same time, that any cleaning composition be effectively streak free, that is to say that the deposition of solids from the cleaning composition and/or the formation of visible streak lines be virtually eliminated. Such technical effects are difficult to provide in a hard surface cleaning composition as improved cleaning typically require increased amounts of organic solvents and synthetic surfactants which while improving cleaning, also contribute to the deposition of undesired solids and/or visible streaking from hard surfaces treated with such compositions.

Accordingly there is a real and continuing need in the art for cleaning compositions useful in the cleaning of hard surfaces, particularly in the cleaning of glass and shiny or reflective hard surfaces.

In one aspect the present invention provides a hard surface cleaning composition particularly adapted to the cleaning of hard surfaces especially those having a shiny or reflective character, e.g., glass, mirrors, glazed tiles, polished or burnished metal surfaces, which compositions comprise a cleaning effective amount of an amine oxide surfactant constituent, an alkanolamine constituent and water, and optionally minor amounts of one or more constituents which improve one or more aesthetic or functional characteristics of the inventive compositions wherein the said compositions exhibit minimal streaking or are nonstreaking in character when used to clean such surfaces. The inventive compositions are further characterized in being essentially free of organic solvents, except for the essential alkanolamine constituent.

According to a further aspect of the invention there is provided a hard surface cleaning composition particularly adapted to the cleaning of hard surfaces especially those having a shiny or reflective character, e.g., glass, mirrors, glazed tiles, polished or burnished metal surfaces, which compositions comprise a cleaning effective amount of an amine oxide surfactant constituent, an alkanolamine constituent and water, characterized in being essentially free of organic solvents, except for the essential alkanolamine constituent, and optionally further comprising minor amounts of one or more constituents which improve one or more aesthetic or functional characteristics of the inventive compositions wherein the said compositions exhibit a high degree of retention of the original gloss of a hard surface subsequent to treatment with the composition.

According to a still further aspect of the invention there is provided a hard surface cleaning composition according to the prior inventive aspect which is further characterized as preferably being essentially free of surfactant constituents, except for the essential amine oxide surfactant constituent.

According to a further aspect of the invention there is provided a method for the cleaning of a hard surface, especially glass and shiny or reflective hard surfaces including inter alia, mirrored glass surfaces, polished metal surfaces, burnished metal surfaces and the like which method comprises the step of:

applying a cleaning effective amount of a hard surface cleaning composition according to any of the prior recited inventive aspects to a hard surface in need of such treatment, and concurrently or subsequently, wiping the surface with a cloth, wipe or wiping article.

According to a yet further aspect of the invention there is provided a method of producing an improved cleaning composition as recited herein.

In one aspect of the invention there is provided a hard surface cleaning composition particularly adapted to the cleaning of hard surfaces especially those having a shiny or reflective character which compositions comprise (preferably consist essentially of):

a cleaning effective amount of an amine oxide surfactant constituent,

an alkanolamine constituent, characterized in being essentially free of organic solvents, except for the essential alkanolamine constituent;

water; and,

further optionally, minor amounts of one or more constituents which improve one or more aesthetic or functional characteristics of the inventive compositions wherein:

the said compositions exhibit minimal streaking or exhibit a high degree of retention of the original gloss of a hard surface subsequent to treatment with the composition.

According to a second aspect of the invention there is provided a method of treating a hard surfaces having a shiny or reflective character utilizing the foregoing compositions.

The inventive compositions necessarily comprise an amine oxide constituent. The inventive compositions also include a nonionic amine oxide constituent. Exemplary amine oxides include:
A) Alkyl di(lower alkyl) amine oxides in which the alkyl group has about 10-20, and preferably 12-16 carbon atoms, and can be straight or branched chain, saturated or unsaturated. The lower alkyl groups include between 1 and 7 carbon atoms. Examples include lauryl dimethyl amine oxide, myristyl dimethyl amine oxide, and those in which the alkyl group is a mixture of different amine oxide, dimethyl cocoamine oxide, dimethyl (hydrogenated tallow) amine oxide, and myristyl/palmityl dimethyl amine oxide;
B) Alkyl di(hydroxy lower alkyl) amine oxides in which the alkyl group has about 10-20, and preferably 12-16 carbon atoms, and can be straight or branched chain, saturated or unsaturated. Examples are bis(2-hydroxyethyl)cocoamine oxide, bis(2-hydroxyethyl)tallowamine oxide; and bis(2-hydroxyethyl)stearylamine oxide;
C) Alkylanidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and
D) Alkylmorpholine oxides in which the alkyl group has about 10-20, and preferably 12-16 carbon atoms, and can be straight or branched chain, saturated or unsaturated.

Preferably the amine oxide constituent is an alkyl di (lower alkyl) amine oxide as denoted above and which may be represented by the following structure:

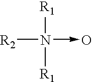

wherein each:

R₁ is a straight chained C₁-C₄ alkyl group, preferably both R₁ are methyl groups; and,

R₂ is a straight chained C₈-C₁₈ alkyl group, preferably is C₁₀-C₁₄ alkyl group, most preferably is a C₁₂ alkyl group.

Each of the alkyl groups may be linear or branched, but most preferably are linear. Most preferably the amine oxide constituent is lauryl dimethyl amine oxide. Technical grade mixtures of two or more amine oxides may be used, wherein amine oxides of varying chains of the R₂ group are present. Preferably, the amine oxides used in the present invention include R₂ groups which comprise at least 50% wt., preferably at least 60% wt. of C₁₂ alkyl groups and at least 25% wt. of C₁₄ alkyl groups, with not more than 15% wt. of C₁₆, C₁₈ or higher alkyl groups as the R₂ group.

The amine oxide constituent may be a single amine oxide, or may be comprised of a plurality of amine oxide compounds and is desirably present in the hard surface cleaning compositions of the invention in amounts of from about 0.01%-10% by weight, more desirably from about 0.5%-5% by weight, yet most preferably from about 0.7-2.5% wt. and most preferably from about 1-2% wt. based on the total weight of the compositions of which they form a part.

According to certain particularly preferred embodiments, the sole surfactant constituent present in the inventive composition is the amine oxide surfactant constituent.

The inventive compositions may, in addition to the required amine oxide surfactant constituent, may include one or more further nonionic surfactants. Nonlimiting examples of such suitable nonionic surfactants which may be used in the present invention include, but are not limited to one or more of the following:

(1) The polyethylene oxide condensates of alkyl phenols. These compounds include the condensation products of alkyl phenols having an alkyl group containing from about 6 to 12 carbon atoms in either a straight chain or branched chain configuration with ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

(2) The condensation products of aliphatic alcohols with from about 1 to about 60 moles of ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). Other examples are those C₆ -C₁₁ straight-chain alcohols which are ethoxylated with from about 3 to about 6 moles of ethylene oxide. Their derivation is well known in the art. Examples include Alfonic® 810-4.5 (also available as Teric G9A5), which is described in product literature from Sasol as a C₈₋₁₀ having an average molecular weight of 356, an ethylene oxide content of about 4.85 moles (about 60 wt. %), and an HLB of about 12; Alfonic® 810-2, which is described in product literature from Sasol as a C₈₋₁₀ having an average molecular weight of 242, an ethylene oxide content of about 2.1 moles (about 40 wt. %), and an HLB of about 12; and Alfonic® 610-3.5, which is described in product literature from Sasol as having an average molecular weight of 276, an ethylene oxide content of about 3.1 moles (about 50 wt. %), and an HLB of 10. Product literature from Sasol also identifies that the numbers in the alcohol ethoxylate name designate the carbon chain length (numbers before the hyphen) and the average moles of ethylene oxide (numbers after the hyphen) in the product.

Further examples of useful nonionic surfactants include alcohol ethoxylates including C₁₀ oxo-alcohol ethoxylates available from BASF under the Lutensol ON tradename. They are available in grades containing from about 3 to about 11 moles of ethylene oxide (available under the names Lutensol ON 30; Lutensol ON 50; Lutensol ON 60; Lutensol ON 65; Lutensol ON 66; Lutensol ON 70; Lutensol ON 80; and Lutensol ON 110). Yet further examples of ethoxylated alcohols include the Neodol® 91 series non-ionic surfactants available from Shell Chemical Company which are described as C₉-C₁₁ ethoxylated alcohols. The Neodol® 91 series non-ionic surfactants of interest include Neodol 91-2.5, Neodol 91-6, and Neodol 91-8. Neodol 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule. Still further examples of ethoxylated alcohols include the Rhodasurf® DA series non-ionic surfactants available from Rhodia which are described to be branched isodecyl alcohol ethoxylates. Rhodasurf DA-530 has been described as having 4 moles of ethoxylation and an HLB of 10.5; Rhodasurf DA-630 has been described as having 6 moles of ethoxylation with an HLB of 12.5; and Rhodasurf DA-639 is a 90% solution of DA-630.

Further examples of ethoxylated alcohols include those from Tomah Products (Milton, Wis.) under the Tomadol tradename with the formula RO(CH₂CH₂O)ₙH where R is the primary linear alcohol and n is the total number of moles of ethylene oxide. The ethoxylated alcohol series from Tomah include 91-2.5; 91-6; 91-8 - where R is linear C9/C10/C11 and n is 2.5, 6, or 8; 1-3; 1-5; 1-7; 1-73B; 1-9; - where R is linear is 3, 5, 7 or 9; 23-1; 23-3; 23-5; 23-6.5 - where R is linear C12/C13 and n is 1, 3, 5, or 6.5; 25-3; 25-7; 25-9; 25-12 - where R is linear C12/C13 C14/C15 and n is 3, 7, 9, or 12; and 45-7; 45-13 - where R is linear C14/C15 and n is 7 or 13.

Other examples of nonionic surfactants include primary and secondary linear and branched alcohol ethoxylates, such as those based on C₆-C₁₈ alcohols which further include an average of from 2 to 80 moles of ethoxylation per mol of alcohol. These examples include the Genapol UD series from Clariant, described as tradenames Genapol UD 030, C₁₁-Oxo-alcohol polyglycol ether with 3 EO; Genapol UD, 050 C₁₁-Oxo-alcohol polyglycol ether with 5 EO; Genapol UD 070, C₁₁-Oxo-alcohol polyglycol ether with 7 EO; Genapol UD 080, C₁₁-Oxo-alcohol polyglycol ether with 8 EO; Genapol UD 088, C₁₁-Oxo-alcohol polyglycol ether with 8 EO; and Genapol UD 110, C₁₁-Oxo-alcohol polyglycol ether with 11 EO.

Other examples of useful nonionic surfactants include those having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Surfactants of this formula are presently marketed under the Genapol® tradename available from Clariant, Charlotte, N.C., include the 26-L series of the general formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1, 26-L-1.6, 26-L-2, 26-L-3, 26-L-5, 26-L-45, 26-L-50, 26-L-60, 26-L-60N, 26-L-75, 26-L-80, 26-L-98N, and the 24-L series, derived from synthetic sources and typically contain about 55% C₁₂ and 45% C₁₄ alcohols, such as 24-L-3, 24-L-45, 24-L-50, 24-L-60, 24-L-60N, 24-L-75, 24-L-92, and 24-L-98N. From product literature, the single number following the “L” corresponds to the average degree of ethoxylation (numbers between 1 and 5) and the two digit number following the letter “L” corresponds to the cloud point in ° C of a 1.0 wt. % solution in water.

(3) Alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):

HO-(EO)ₓ(PO)_{y}(EO)_{z}—H (A)

where EO represents ethylene oxide,
PO represents propylene oxide,
y equals at least 15,
(EO)_{x+y} equals 20 to 50% of the total weight of said compounds, and, the total molecular weight is preferably in the range of about 2000 to 15,000. These surfactants are available under the PLURONIC tradename from BASF or Emulgen from Kao.

Another group of nonionic surfactants appropriate for use in the new compositions can be represented by the formula (B):

R-(EO,PO)ₐ(EO,PO)_{b}—H (B)

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further useful nonionic surfactants containing polymeric butoxy (BO) groups can be represented by formula (C) as follows:

RO—(BO)ₙ(EO)ₓ—H (C)

wherein R is an alkyl group containing I to 20 carbon atoms,
n is about 5-15 and x is about 5-15.

Also useful as the nonionic block copolymer surfactants, which also include polymeric butoxy groups, are those which may be represented by the following formula (D):

HO-(EO)ₓ(BO)ₙ(EO)_{y}—H (D)

wherein n is about 5-15, preferably about 15,
x is about 5-15, preferably about 15, and
y is about 5-15, preferably about 15.

Still further useful nonionic block copolymer surfactants include ethoxylated derivatives of propoxylated ethylene diamine, which may be represented by the following formula:

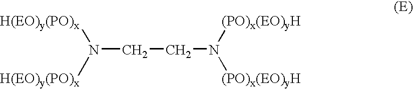

where (EO) represents ethoxy,
(PO) represents propoxy,
   the amount of (PO)ₓ is such as to provide a molecular weight prior to ethoxylation of about 300 to 7500, and the amount of (EO)_{y} is such as to provide about 20% to 90% of the total weight of said compound.

Two or more surfactants may be included in the compositions of the invention. When present such a further nonionic surfactant(s) is present in the compositions of the present invention in an amount of from about 0.001 to about 10% by weight, preferably in amounts of from about 0.01-4% wt. but more preferably from about 0.05-3% wt. Particularly preferred nonionic surfactant is constituents and weight percentages are described with reference to one or more of the Examples.

The inventive compositions necessarily also comprise an alkanolamine constituent which provides alkalinity to the compositions, as well as simultaneously providing excellent removal of hydrophobic soils which may be encountered, e.g., greases and oils. Exemplary useful alkanolamines include monoalkanolamines, dialkanolamines, trialkanolamines, and alkylalkanolamines such as alkyl-dialkanolamines, and dialkyl-monoalkanolamines. The alkanol and alkyl groups are generally short to medium chain length, that is, from 1 to 7 carbons in length. For di- and trialkanolamines and dialkyl-monoalkanolamines, these groups can be combined on the same amine to produce for example, methylethylhydroxypropylhydroxylamine. One of skill can readily ascertain other members of this group. The alkanolamine constituent may be a single alkanolamine, or may be a plurality of alkanolamines and is desirably present in the hard surface cleaning compositions of the invention in amounts of from about 0.01% -10% by weight, more desirably from about 0.01% -2% by weight, and most preferably from about 0.01-1% wt. based on the total weight of the compositions of which they form a part.

Particularly preferred as the alkanolamine constituent is monoethanolamine which has found to be effective both as an alkalinity source and as a cleaning component. In certain particularly preferred embodiments the alkanolamine constituent of the invention consists solely of a single alkanolamine, preferably selected from monoalkanolamines, dialkanolamines, trialkanolamines of 1 to 7 carbons in length, preferably is a single monoalkanolamine selected from linear monoethanolamine, monopropanolamine or monobutanolamine, and especially preferably is monoethanolamine.

Water is the primary constituent of the inventive compositions as the compositions are largely aqueous in nature, and comprise at least 75% wt., preferably at least about 80% wt. water, more preferably at least about 90% wt. water, still preferably at least 93% wt., and yet more preferably comprise at least 95% wt. water. The amount of water is added to order to provide to 100% by weight of the compositions of the invention. The water may be tap water, but is preferably distilled and is most preferably deionized water. If the water is tap water, it is preferably substantially free of any undesirable impurities such as organics or inorganics, especially minerals salts which are present in hard water which may thus undesirably interfere with the operation of the constituents present in the aqueous compositions according to the invention.

As noted, the inventors have surprisingly observed that the present inventive compositions exhibit good cleaning of glass, glassy, mirrored an polished hard surface such that effective cleaning is provided, while simultaneously essentially low streaking, or preferably an essentially streak free cleaning benefit is provided. Such is particularly surprising in the absence of known art volatile organic compositions which, save for the alkanolamine constituent, are omitted from the inventive compositions. Representative species of such omitted volatile organic solvents include at least partially water-miscible such as alcohols (e.g., low molecular weight alcohols, such as, for example, ethanol, propanol, isopropanol, and the like), many higher molecular weight alcohols (e.g., n-octanol, n-decanol), glycols (e.g., ethylene glycol, propylene glycol, hexylene glycol, and the like), water-miscible ethers (e.g., diethylene glycol diethylether, diethylene glycol dimethylether, propylene glycol dimethylether), water-miscible glycol ether (e.g., propylene glycol monomethylether, propylene glycol mono ethylether, propylene glycol monopropylether, propylene glycol monobutylether, ethylene glycol monobutylether, dipropylene glycol monomethylether, diethyleneglycol monobutylether), lower esters of monoalkylethers of ethylene glycol or propylene glycol (e.g., propylene glycol monomethyl ether acetate), and mixtures thereof.

The compositions of the present invention can also optionally comprise one or more further constituents which are directed to improving the aesthetic or functional features of the inventive compositions. Such conventional additives known to the art include but not expressly enumerated here may also be included in the compositions according to the invention. By way of non-limiting example without limitation these may include: chelating agents, coloring agents, light stabilizers, fragrances, thickening agents, hydrotropes, pH adjusting agents, pH buffers as well as one or more detersive surfactants as noted previously. Many of these materials are known to the art, per se, and are described in McCutcheon's Detergents and Emulsifiers, North American Edition, 1998; Kirk-Othmer, Encyclopedia of Chemical Technology, 4th Ed., Vol. 23, pp. 478-541 (1997. Such optional, i.e., non-essential constituents should be selected so to have little or no detrimental effect upon the desirable characteristics of the present invention. When present, the one or more optional constituents present in the inventive compositions do not exceed about 10% wt., preferably do not exceed 8% wt., and most preferably do not exceed 5% wt.

Advantageously included constituents are one or more coloring agents which find use in modifying the appearance of the compositions and enhance their appearance from the perspective of a consumer or other end user. Known coloring agents, such as dyestuffs may be incorporated in the compositions in effective amounts.

The compositions of the invention optionally but in certain cases desirably include a fragrance constituent. Fragrance raw materials may be divided into three main groups: (1) the essential oils and products isolated from these oils; (2) products of animal origin; and (3) synthetic chemicals.

The essential oils consist of complex mixtures of volatile liquid and solid chemicals found in various parts of plants. Mention may be made of oils found in flowers, e.g., jasmine, rose, mimosa, and orange blossom; flowers and leaves, e.g., lavender and rosemary; leaves and stems, e.g., geranium, patchouli, and petitgrain; barks, e.g., cinnamon; woods, e.g., sandalwood and rosewood; roots, e.g., angelica; rhizomes, e.g., ginger; fruits, e.g., orange, lemon, and bergamot; seeds, e.g., aniseed and nutmeg; and resinous exudations, e.g., myrrh. These essential oils consist of a complex mixture of chemicals, the major portion thereof being terpenes, including hydrocarbons of the formula (C₅H₈)ₙ and their oxygenated derivatives. Hydrocarbons such as these give rise to a large number of oxygenated derivatives, e.g., alcohols and their esters, aldehydes and ketones. Some of the more important of these are geraniol, citronellol and terpineol, citral and citronellal, and camphor. Other constituents include aliphatic aldehydes and also aromatic compounds including phenols such as eugenol. In some instances, specific compounds may be isolated from the essential oils, usually by distillation in a commercially pure state, for example, geraniol and citronellal from citronella oil; citral from lemon-grass oil; eugenol from clove oil; linalool from rosewood oil; and safrole from sassafras oil. The natural isolates may also be chemically modified as in the case of citronellal to hydroxy citronellal, citral to ionone, eugenol to vanillin, linalool to linalyl acetate, and safrol to heliotropin.

Animal products used in perfumes include musk, ambergris, civet and castoreum, and are generally provided as alcoholic tinctures.

The synthetic chemicals include not only the synthetically made, also naturally occurring isolates mentioned above, but also include their derivatives and compounds unknown in nature, e.g., isoamylsalicylate, amylcinnamic aldehyde, cyclamen aldehyde, heliotropin, ionone, phenylethyl alcohol, terpineol, undecalactone, and gamma nonyl lactone.

Fragrance compositions as received from a supplier may be provided as an aqueous or organically solvated composition, and may include as a hydrotrope or emulsifier a surface-active agent, typically a surfactant, in minor amount. Such fragrance compositions are quite usually proprietary blends of many different specific fragrance compounds. However, one of ordinary skill in the art, by routine experimentation, may easily determine whether such a proprietary fragrance composition is compatible in the compositions of the present invention.

Ideally the inclusion of any further constituents which are directed to improving the aesthetic or functional features of the inventive compositions should be minimized in order to minimize the likelihood of the deposition of solids on the treated hard surfaces, particularly on mirrors as well in minimizing the likelihood of streaking of such hard surfaces even when such further optional constituents are included. The selection of such optional constituents which present a minimal likelihood of forming deposits or of imparting streaking to treated surfaces may be determined by routine experimentation by a skilled artisan, and are desirably selected for use in the compositions. When one or more such optional constituent are present, preferably, in total they comprise not more than 1% wt., more preferably not more than 0.75% wt, still more preferably not more than 0.50% wt., and most preferably not more than 0.35% wt of an inventive composition of which they form a part.

The present inventors have surprisingly observed that notwithstanding the low amount of active constituents, the inventive compositions provide an excellent cleaning benefit to treated hard surface while resulting in minimal or no streaking of the treated hard surfaces. Alternately it may be stated that the present inventors have surprisingly observed that notwithstanding the low amount of active constituents, the inventive compositions provide an excellent cleaning benefit to treated hard surface while resulting in a high degree of retention of the original gloss of the hard surface being treated by the inventive compositions, typically on the order of 60%, or more, and especially on the order of about 70% or more. This result is surprising particularly in view of the amounts of the amine oxide surfactant present in the preferred embodiments of the invention which are moderate to high foaming nonionic surfactants which would be expected to deposit solids or residues which would result in visible strealing even after wiping with a cloth, wipe or other wiping article. This result is even more surprising in view of the fact that in accordance with particularly preferred embodiments further organic solvents, e.g., monohydric alcohols, polyhydric alcohols, glycols, ethers, glycol ethers, acetate solvents, further hydrocarbon solvents such as mineral spirits as well as benzene, pyrrolidone include structural analogues of N-methylpyrrolidone, for example N-methylpyrrolidone and N-propylpyrrolidone are essentially absent from the inventive compositions. Certain of these organic solvents, e.g., alcohols and glycols are known to be used glass cleaning compositions to provide both an effective cleaning benefit and to improve the evaporative characteristics of such compositions. Such further organic solvents are not required in the inventive compositions, and are most desirably, excluded.

The compositions exhibit a pH in the range of about 8 to 12, preferably a pH of about 10-11 and most preferably a pH in the range of 10.5-11.5.

Particularly preferred compositions of the invention are glass and hard surface cleaning compositions which comprise (preferably consist essentially of):

0.01-2% wt. of an amine oxide constituent, preferably a single amine oxide constituent, and especially preferably wherein the sole detersive surfactant present is a single amine oxide constituent;

0.01-1% wt. of an alkanolamine constituent, preferably a single monoalkanolamine selected from linear monoethanolamine, monopropanolamine or monobutanolamine, and especially preferably is monoethanolamine, particularly preferably where in the alkanolamine constituent is the sole organic solvent constituent present in the compositions;

the balance to 1 00% wt. of water, preferably deionized water;

further optionally but in some cases preferably one or more further optional constituents which are directed to improving the aesthetic or functional features of the inventive compositions including coloring agents and fragrances;

wherein the compositions are characterized in being essentially free of organic solvents, except for the essential alkanolamine constituent and further wherein the compositions are particularly effective in the cleaning of hard surface, especially glass and shiny or reflective hard surfaces while imparting minimal streaking or imparting little or no surface residues.

The compositions of the inventions may be produced by simple mixing of the constituents in water, preferably at least a major proportion of the deionized water is provided at room temperature to which is added under constant stirring the surfactant constituent, followed by the organic solvent constituent, and finally any optional constituent which may be included. Mixing continues until a homogenous mixture of the constituents is formed, after which mixing may be stopped and the compositions are ready for use. These as mixed compositions are preferably used without further dilution prior to their use in the treatment of hard surfaces.

The compositions of the invention may be formulated so to be supplied in as non-pressurized containers such as rigid containers or flasks, as well as in deformable containers or flask from which the inventive compositions may be dispensed. The non-pressurized containers may be provided with a conventional trigger-pump spray apparatus which when actuated by a user, is used to withdraw a quantity of the composition from the container and expel it from the trigger-pump spray apparatus as a spray or stream which may be directed to a hard surface in need of treatment.

The compositions of the invention may be formulated with conventional propellants for dispensing as aerosols from conventional pressurized containers. Propellants which may be used are well known and conventional in the art and include, for example, a hydrocarbon, of from 1 to 10 carbon atoms, such as n-propane, n-butane, isobutane, n-pentane, isopentane, and mixtures thereof; dimethyl ether and blends thereof as well as individual or mixtures of chlorofluoro- and/or fluorohydrocarbons- and/or hydrochlorofluorocarbons (HCFCs). Useful commercially available hydrocarbon based propellant compositions include A-70 (Aerosol compositions with a vapor pressure of 70 psig available from companies such as Diversified and Aeropress.), as well as fluorocarbon based propellant compositions such as DYMEL 152A (commercially available from DuPont.) Compressed gases such as carbon dioxide, compressed air, nitrogen, and possibly dense or supercritical fluids may also be used.

The amount of propellant employed should provide a suitable spray pattern and for essentially complete expulsion of the composition from the aerosol container. The appropriate amount to be used for any particular aerosol propellant system can readily be determined by one skilled in the art. Preferably, the propellants comprise about 1% to about 50% of the aerosol formulation with preferred amounts being from about 2% to about 25%, more preferably from about 5% to about 15%. Generally speaking, the amount of a particular propellant employed should provide an internal pressure of from about 20 to about 150 psig at 70° F.

The composition of the present invention, can also be applied to a hard surface by using a wet wipe preimpreganted with a quantity of the inventive composition. The wipe can be of a woven or non-woven nature. Fabric substrates can include nonwoven or woven pouches, sponges, in the form of abrasive or non-abrasive cleaning pads. Such fabrics are known commercially in this field and are often referred to as wipes. Such substrates can be resin bonded, hydroentangled, thermally bonded, meltblown, needlepunched, or any combination of the former.

Such nonwoven fabrics may be a combination of wood pulp fibers and textile length synthetic fibers formed by well known dry-form or wet-lay processes. Synthetic fibers such as rayon, nylon, orlon and polyester as well as blends thereof can be employed. The wood pulp fibers should comprise about 30 to about 60 percent by weight of the nonwoven fabric, preferably about 55 to about 60 percent by weight, the remainder being synthetic fibers. The wood pulp fibers provide for absorbency, abrasion and soil retention whereas the synthetic fibers provide for substrate strength and resiliency. The substrate of the wipe may also be a film forming material such as a water soluble polymer. Such self-supporting film substrates may be sandwiched between layers of fabric substrates and heat sealed to form a useful substrate. The free standing films can be extruded utilizing standard equipment to devolatilize the blend. Casting technology can be used to form and dry films or a liquid blend can be saturated into a carrier and then dried in a variety of known methods.

The compositions of the present invention are absorbed onto the wipe to form a saturated wipe. The wipe can then be sealed individually in a pouch which can then be opened when needed or a multitude of wipes can be placed in a container for use on an as needed basis. The container, when closed, sufficiently sealed to prevent evaporation of any components from the compositions.

The compositions are readily used in the cleaning of hard surfaces by application a cleaning effective amount of a hard surface cleaning composition according to any of the prior recited inventive aspects to a hard surface in need of such treatment, and concurrently or subsequently, wiping the surface with a cloth, wipe or wiping article.

The following examples exhibits exemplary and preferred formulations of the invention. It is to be understood that these examples are provided by way of illustration only and that further useful formulations falling within the scope of the present invention and the claims may be readily produced by one skilled in the art without deviating from the scope and spirit of the invention.

### EXAMPLES

Formulation according to the invention were produced by mixing the constituents outlined in Table 1 by adding the individual constituents into a beaker of deionized water at room temperature which was stirred with a conventional magnetic stirring rod. Stirring continued until each of the formulations were homogenous in appearance. It is to be noted that the constituents might be added in any order, but it is preferred that a major proportion of water be the initial constituent provided to a mixing vessel or apparatus as it is the major constituent and addition of the further constituents thereto is convenient.

TABLE 1

| | Ex. 1 | Ex. 2 | Ex. 3 | Ex. 4 |
|---|---|---|---|---|
| lauryl dimethyl amine oxide | 1.5 | 1.2 | 0.6 | 0.6 |
| linear primary C8-C10 | — | 1.5 | — | 3.0 |
| alcohol ethoxylate, 4.5 mols | | | | |
| ethoxylation (avg) | | | | |
| monoethanolamine | 0.75 | 0.75 | 0.75 | 0.75 |
| fragrance (proprietary | 0.3 | 0.3 | 0.3 | 0.3 |
| composition) | | | | |
| FC&C Yellow #5 (colorant) | 0.0005 | 0.0005 | 0.0005 | 0.0005 |
| water (deionized) | q.s. | q.s. | q.s. | q.s. |

The quantity of each identified constituents used to produce the formulations of Table 1 is indicated in weight percent. As indicated, deionized water was added to each formulation in quantum sufficient, “q.s.” to provide the balance to 100% wt. of each of the example compositions. Each of the foregoing identified constituents from Table 1 are to be considered as having a 99-100% wt. actives concentration.

Samples of each of the compositions of Table 1 were supplied to a non-pressurized vessel supplied with a conventional trigger-pump spray apparatus which was used to subsequently dispense the composition. A quantity of each sample composition were sprayed onto a bathroom mirror in need of cleaning, and a folded paper towel was used to distribute and to wipe the surface of the bathroom mirror bearing the sprayed composition. It was observed that subsequent to wiping, excellent cleaning was provided and a non-streaked mirrored surface resulted. Such a result was surprising in consideration of the relatively high amount of the foaming amine oxide surfactant present, and with only the alkanolanine present in the composition in the absence of further volatile organic solvents.

Certain of the compositions of Table 1 were further evaluated for their cleaning performance, and in some instances in comparison with comparative formulations which included a further volatile organic solvent, dipropylene glycol n-butyl ether. Such comparative formulations form no part of the present invention. Certain of these comparative formulations were produced in the same manner as those used to form the formulations of Table 1 from the same materials used to form the compositions of Table 1; these comparative compositions are noted on Table 2.

TABLE 2
(comparative compositions)

| | C2 | C4 |
|---|---|---|
| lauryl dimethyl amine oxide (30% wt.) | 1.5 | 0.6 |
| linear primary C8-C10 alcohol ethoxylate, 4.5 mols | 1.5 | 3.0 |
| ethoxylation (avg) | | |
| dipropylene glycol n-butyl ether | 3.0 | 3.0 |
| monoethanolamine | 0.75 | 0.75 |
| fragrance (proprietary composition) | 0.3 | 0.3 |
| FC&C Yellow #5 (colorant) | 0.0005 | 0.0005 |
| water (deionized) | q.s. | q.s. |

The comparative composition C2 was similar to Ex. 2, while comparative composition C4 was similar to Ex.4 with both of the comparative compositions adding 3% wt. of the glycol ether to each.

### Cleaning of Organic Soil

Cleaning evaluations were performed in accordance with the testing protocol outlined according to ASTM D4488 A2 Test Method, which evaluated the efficacy of the cleaning compositions in removing greasy soil on masonite wallboard samples painted with wall paint. The soil applied was a greasy soil sample containing:

| Test Greasy Soil | % w/w |
|---|---|
| Vegetable oil | 33 |
| Vegetable shortening | 33 |
| Lard | 33 |
| Carbon black | 1 |

which were blended together to homogeneity under gentle heating to form a uniform mixture which was later allowed to cool to room temperature. The sponge (water dampened) of a Gardner Abrasion Tester apparatus was squirted with a 15 gram sample of a tested cleaning composition, and the apparatus was cycled 10 times. The test was replicated 2 times for each tested composition. The tiles were dried, and then the cleaning efficacy was evaluated.

Each dried tested tiles was evaluated using a micro-Tri-Gloss meter (ex. Byk-Gardner Inc.) at 60 degrees, and 3 readings were taken at randomly selected points of the cleaned surface in order to determine surface reflectance. According to the reflective means, the percentage of soap scum removal from each tile was determined utilizing the following equation:

$$\% Removal = \frac{RC - RS}{RO - RS} \times 100$$

where

RC=Reflectance of tile after cleaning with test product

RO=Reflectance of original soiled tile

RS=Reflectance of soiled tile

The results of this evaluation was averaged for each of the tested compositions, and the results of the evaluation are reported on the following table.

Each of these tests were duplicated on 5 wallboard tiles and the results statistically analyzed and the averaged results reported on Table 3, below. The cleaning efficacy of the tested compositions was evaluated utilizing a Minolta Chroma Meter CF-110, with Data Processor DP-100, which evaluated spectrophotomic characteristics of the sample. The results are reported on Table 3, following.

TABLE 3

| Composition | Average % Soil Removal |
|---|---|
| Ex. 2 | 75.85 |
| Ex. 3 | 55.26 |
| Ex. 4 | 70.84 |
| C2 | 68.74 |
| C4 | 83.86 |

With respect to the results reported on Table 3 a value of “100” is indicative of total soil removal and a “0” value is indicative no soil removal. As can be seen from the results of Table 3, the cleaning efficacy of the composition according to the invention generally provided superior results or were only slightly lesser in cleaning performance with the comparative compositions. Such results are still to be considered as surprisingly good, in view of the omission of the 3% wt. of the glycol ether constituent resulting in only a minor reduction in cleaning efficacy.

### Cleaning of Glossy Hard Surface

Cleaning evaluations were performed in accordance with the testing protocol in order to determine the degree of gloss retention on nonporous glazed glossy black bathroom tiles which provides an indicia of the reduced streaking characteristics of the compositions of the present invention.

Initially each of the test tiles were first cleaned with a detergent composition, then rinsed with water and isopropanol and thereafter were allowed to dry completely. The test tiles used were standard four inch by four inch nonporous glazed glossy black bathroom tiles. After each of the tiles were fully dried, a white adhesive tape was applied to the glazed surface in order to bisect the glazed surface. Each side of the tile surface was then evaluated using a micro-Tri-Gloss meter (ex. Byk-Gardner Inc.) for initial gloss at a 60° angle.

Subsequently samples of compositions, both according to the invention and according to comparative examples were applied to replicates of the prepared tiles. Two different compositions were tested on each of the prepared tiles. A Garner Abrasion Tester was used. First the standard cellulose sponge used with the device was overwrapped in a nonporous plastic film to ensure that no composition used in the test would be absorbed by the sponge. For each formulation tested a clean, dry C-fold paper towel was wrapped about the overwrapped sponge and then the sponge and paper towel was reinserted into the carrier of the Gamer Abrasion Tester. Care was taken to ensure that an unfolded surface of the paper towel was used in contacting the surface of a prepared tile. Thereafter a prepared tile was installed into the device, such that when operated the sponge and paper towel would transit one of the bisected surfaces of the tile. Next, 2 grams of a test composition was then evenly applied to one side of the prepared tile surface, and the device cycled four times thus imparting a controlled scrubbing effect on the face of the glossy black tile. The foregoing test was repeated for the other side of the prepared tile using a different composition on the other side of bisected surface of the tile using a different test composition, and then the tile, having been tested on each of the bisected sides was removed from the device and inserted into a vertical rack and each of the tiles were allowed to dry overnight at room temperature. The next day, each of the surfaces of the tiles were evaluated using the micro-Tri-Gloss meter to determine the final gloss at a 60° angle. The gloss retention was calculated using the following equation:

$$\% gloss retention = \frac{gloss reading ( after testing )}{gloss reading ( before testing )} \times 100$$

For each of the tested compositions, 5 prepared tile replicates were used, and the averaged %gloss retention value is reported on the following table.

| Composition: | % gloss retention |
|---|---|
| C2 | 88.37 |
| C4 | 82.38 |
| E2 | 78.25 |
| E4 | 74.07 |

As can be seen from the foregoing reported results, the compositions according to the invention (E2, E5) exhibited only slightly reduced gloss retention than the comparative compositions (C4, C4) each of which included 3% wt. of a volatile glycol ether. The test results demonstrate that a high degree of retention of the original surface gloss of the substrate is retained following treatment with the inventive compositions.

While the invention is susceptible of various modifications and alternative forms, it is to be understood that specific embodiments thereof have been shown by way of example which are not intended to limit the invention to the particular forms disclosed; on the contrary the intention is to cover all modifications, equivalents and alternatives falling within the scope and spirit of the invention as expressed in the appended claims.

1. A hard surface cleaning composition particularly adapted to the cleaning of hard surfaces especially those having a shiny or reflective character which compositions comprise:
a cleaning effective amount of an amine oxide surfactant constituent, an alkanolamine constituent, characterized in being essentially free of organic solvents, except for the essential alkanolamine constituent;
water; and,
further optionally, minor amounts of one or more constituents which improve one or more aesthetic or functional characteristics of the inventive compositions wherein:
the said compositions exhibit minimal streaking or exhibit a high degree of retention of the original gloss of a hard surface subsequent to treatment with the composition.

2. A composition according to claim 1 wherein the amine oxide surfactant constituent is present in an amount of 0.01%-10% by weight.

3. A composition according to claim 2 wherein the amine oxide surfactant constituent is present in an amount of 0.01%-5% by weight.

4. A composition according to claim 3 wherein the amine oxide surfactant constituent is present in an amount of 0.01%-5% by weight.

5. A composition according to claim 4 wherein the amine oxide surfactant constituent is present in an amount of 0.01%-2% by weight.

6. A composition according to claim 1 wherein the amine oxide constituent is the sole detersive surfactant present in the composition.

7. A composition according to claim 1 wherein the alkanolamine constituent is present in an amount of from 0.01-10% wt.

8. A composition according to claim 7 wherein the alkanolamine constituent is present in an amount of from 0.01-2% wt.

9. A composition according to claim 8 wherein the alkanolamine constituent is present in an amount of from 0.01-1% wt.

10. A composition according to claim 1 wherein the alkanolamine constituent is a single monoalkanolamine selected from linear monoethanolamine, monopropanolamine or monobutanolamine, and preferably is monoethanolamine.

11. A composition according to claim 1 which in addition to the amine oxide, comprises one or more further nonionic surfactants.

12. A composition according to claim 11 wherein the further nonionic surfactant is one or more alcohol ethoxylates.

13. A composition particularly adapted to the cleaning of hard surfaces especially those having a shiny or reflective character which compositions consist essentially of:
0.01%-10%, preferably 0.015% by weight of an amine oxide surfactant constituent which is present as the sole detersive surfactant present in the composition,
0.01-10%, preferably 0.012% by weight of an alkanolamine constituent selected from linear monoethanolamine, monopropanolamine or monobutanolamine wherein the alkanolamine constituent is the sole organic solvent constituent present in the composition; and,
water,
further optionally, minor amounts of one or more constituents which improve one or more aesthetic or functional characteristics of the inventive compositions;
wherein the said compositions exhibit minimal streaking or are nonstreaking in character when used to clean such surfaces.

14. A method of producing the composition according to claim 1 which method comprises the steps of:
providing the constituents to water under constant stirring, and continuing stirring until a final homogenous mixture of the constituents are formed.

15. A ready to use composition packaged in a non-pressurized container comprising a composition according to claim 1.

16. A ready to use composition packaged in a pressurized aerosol container comprising a composition according to claim 1.

17. A preimpregnated wet wipe article comprising a composition according to claim 1.

18. A method of cleaning a hard surface in need of a cleaning treatment which method comprises the step of:
applying a cleaning effective amount of the composition according to claim 1 to said surface, and optionally but desirably thereafter wiping the treated surface with a wiping article.
